(19) United States
(12) Patent Application Publication
(10) Pub. No.: US 2010/0172725 A1
(43) Pub. Date: Jul. 8, 2010

(54) Receiving and Presenting Parts to an Operating Station

(75) Inventors: James H. Pajot, Fenton, MI (US); Craig A. Rodriguez, Rochester Hills, MI (US)

Correspondence Address: MacMillan, Sobanski & Todd, LLC;One Maritime Plaza, 720 Water Street, 5th Floor, Toledo, OH, 43604, US

(73) Assignee: GM GLOBAL TECHNOLOGY OPERATIONS, INC., Detroit, MI (US)

(21) Appl. No.: 12/349,533

(22) Filed: Jan. 7, 2009

(51) Int. Cl. B65G 67/22; B66F 9/02; B66F 9/075

(52) U.S. Cl. 414/335; 414/680; 414/742; 414/334; 414/809

(57) ABSTRACT

A transfer device for transporting parts includes a rotatable stand including first and second angularly spaced arms secured to the stand and able to rotate between a first location where parts are installed on the first arms and a second location where the parts are removed from the first arms, and actuators for raising and lowering the arms.

### BACKGROUND OF INVENTION

The present invention relates generally to an apparatus for receiving and presenting parts to an operating station in an industrial plant where components are being manufactured, processed or assembled.

The trend toward a fork truck free environment in a manufacturing plant has resulted in the use of containers presented on dollies. Many of the shipping containers are only partially filled in order to comply with reach-and-part-pick ergonomics.

In a manufacturing plant conventional methods and apparatus for transporting large parts do not permit effective presentation of the parts to the production operator in the space available without the operator having to walk from his station to retrieve the parts. Effective presentation of the parts would display multiple styles of large parts, such as doors of body sides, to the production operator while in the operation station.

To overcome this shortcoming, an off-line area is set up to sequence the parts to the operator. But this adds considerable cost to the process. Preferably the parts would be placed closely, i.e., the part density would be high and would allow direct parts placement without sequencing.

A need exists in the industry for a parts delivery system that would present material to production operators in a containerless manner with little or no interruption to the work cycle or process and in as small a space as possible. Preferably the system would reduce handling costs, require minimal support space, and deliver the parts to the operator without a fork truck.

### SUMMARY OF INVENTION

A transfer device for receiving and presenting parts includes a rotatable stand including first and second angularly spaced arms secured to the stand and able to rotate between a first location where parts are installed on the first arms and a second location where the parts are removed from the first arms, and actuators for raising and lowering the arms.

The invention contemplates a method for operating a transfer device including providing a rotatable stand including first and second angularly spaced arms able to rotate about an axis between first and second locations, moving a cart carrying a batch of parts to the first location such that the first arms engage and lift the batch from the cart, raising the first arms and the batch of parts from the cart, and rotating the batch of parts to the second location. When empty of parts and raised to a rotation position, the second arms are rotated to the first location concurrently with rotating the batch of parts to the second location, thus making the second arms available to receive the next delivery of parts.

The transfer device presents parts to the production operator without a shipping/storage container, allows transfer devices to be positioned close together due to the empty arms of the one device being lifted above those of the adjacent device, and unloads the parts directly from the container or delivery cart without the use of a fork lift.

The transfer device provides improved ergonomics for the production operator, requires no loss of throughput during parts replenishment, provides improved ergonomics for the material delivery operator, and enables a higher part density in delivery containers or carts, thereby resulting in lower container investment and associated handling and freight costs.

The scope of applicability of the preferred embodiment will become apparent from the following detailed description, claims and drawings. It should be understood, that the description and specific examples, although indicating preferred embodiments of the invention, are given by way of illustration only. Various changes and modifications to the described embodiments and examples will become apparent to those skilled in the art.

### BRIEF DESCRIPTION OF DRAWINGS

FIG. 1 is a side view showing a cart carrying parts to a transfer device;

FIG. 2 is a side view showing parts lifted from the cart by the transfer device;

FIG. 3 is a front view of the transfer device;

FIG. 4 is a top view of the transfer device; and

FIG. 5 is a side view of the transfer device.

### DETAILED DESCRIPTION

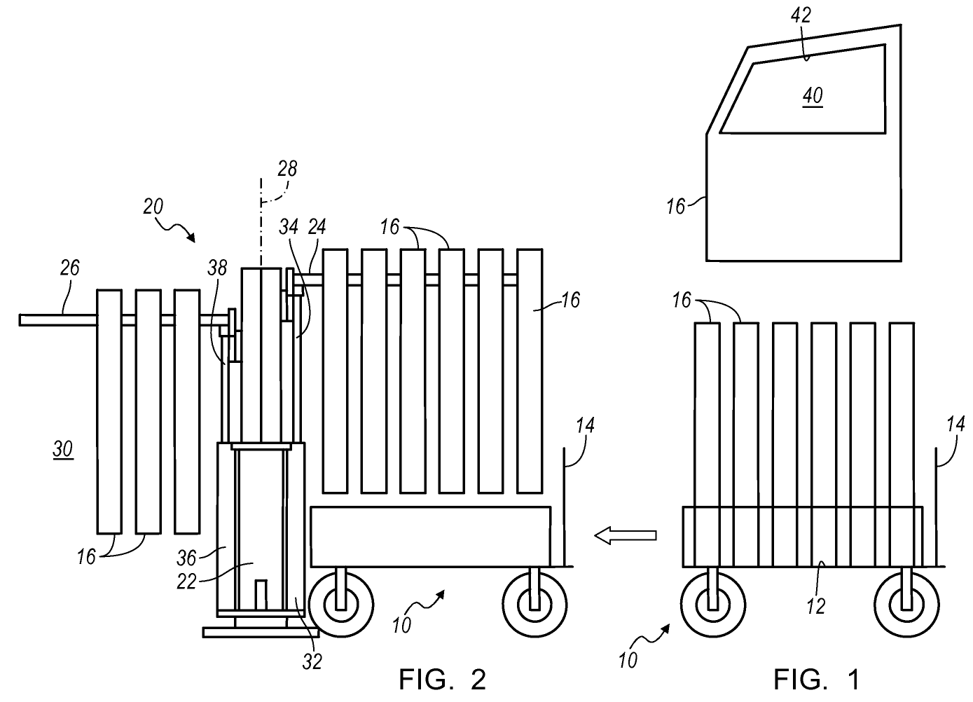

Referring now to the drawings, there is illustrated in FIG. 1 a wheeled cart 10 having a load bed 12 and a hand rail 14. At least some of the wheels swivel to facilitate steering the cart manually. The load bed 12 is shown filled with parts 16, which in the example being described are door panels for an automobile. Normally a materials operator manually grips the rail 14 and guides the cart 10 to a production workstation, where further manufacturing operations are performed on the door panels 16. The cart 10 may be positioned via powered equipment if the load is too heavy for manual pushing. A fork lift may also be used to position the parts on the receiving arms of the device.

FIG. 2 shows the cart 10 located before a transfer device 20 in the form of a turnstile having a stand 22 with arms or pairs of arms 24, 26, each arm being able to rotate about an axis 28 between the location of the cart 10 and a production workstation, indicated generally at 30. Arms 24, 26 extend radially from axis 28 and rotate sequentially such that when arms 24 are directed from axis 28 toward the location of the cart, arms 26 are directed from the axis toward the workstation 30. When arms 26 are directed toward the location of the cart, arms 24 are directed toward workstation 30.

The inner end of arms 24 is attached to a lift cylinder 32 containing a piston 34, which may be actuated electrically or by pneumatic or hydraulic pressure in the cylinder, to raise and lower arms 24. Similarly, inner end of arms 26 is attached to a lift cylinder 36 containing a piston 38, which is actuated by pneumatic pressure in the cylinder to raise and lower arms 26.

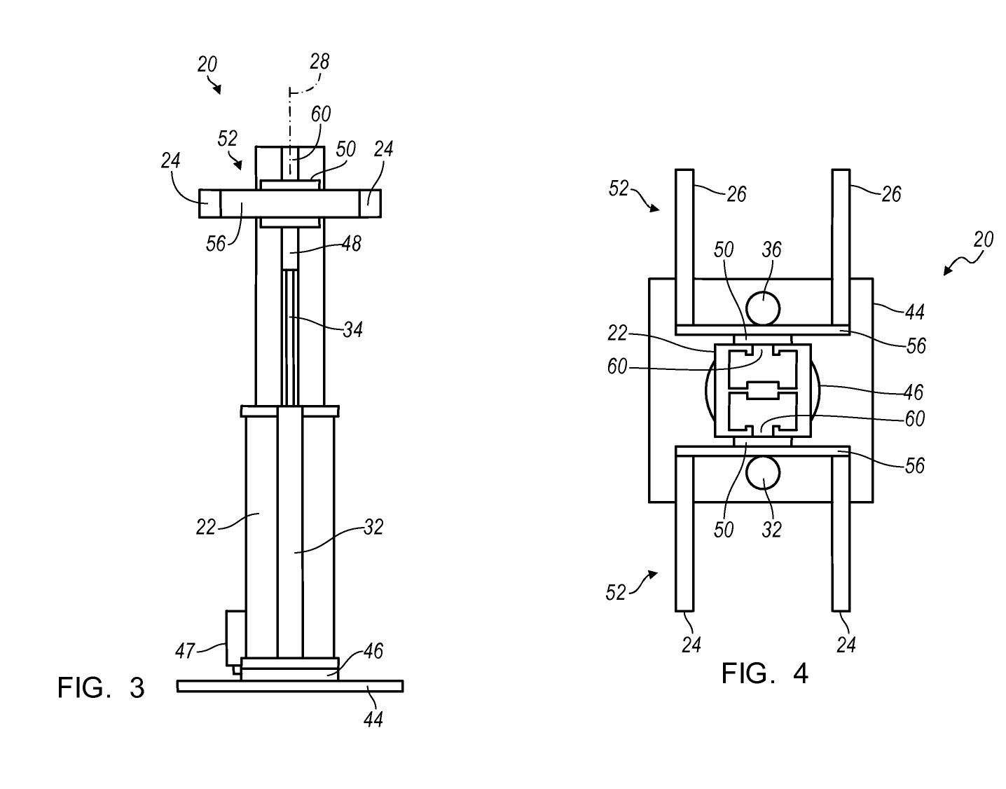

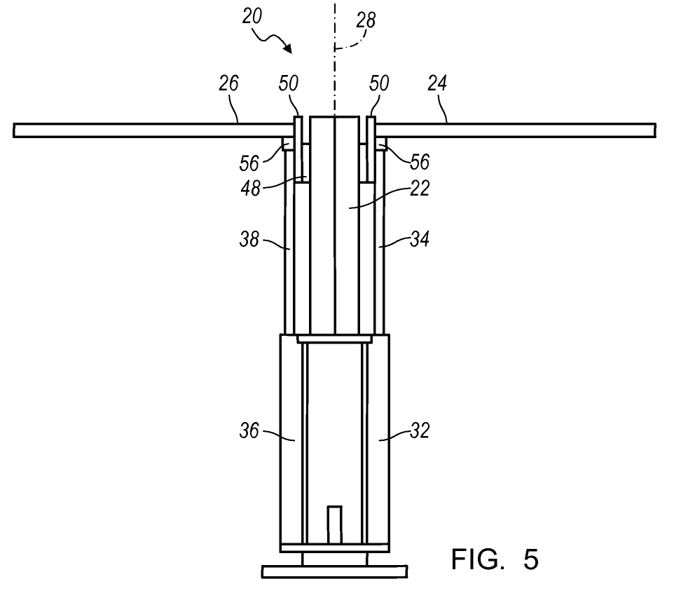

As FIGS. 3, 4 and 5 illustrate, the transfer device 20 further includes a floor mount plate 44, stewing bearing 46, trolleys 48, mount plates 50 and turnstile arm assemblies 52.

The mount plate 44 is secured to the floor. The slewing bearing 46 rests on plate 44 and supports the stand 22 for rotation about axis 28. An air motor 47 may be used to turn the stand about axis 28, or the stand may be turned manually by applying a turning force to the arms 24, 26.

Each lift cylinder 32, 36 is sized in bore and stroke to facilitate the required lift height and weight of the parts it carries.

Each turnstile arm assembly 52 includes a cross member 56, secured to a mount plate 50, which is secured to a trolley 48. Each cross member carries a pair of arms 24, 26.

The stand is formed with vertical rails 60, in each of which a trolley 48 is guided and moves when actuated by a respective cylinder 32, 36 to raise and lower the arms 24, 26. Each cross member carries a pair of arms 24, 26.

In operation, the cart 10 is moved to the transfer device 20 such that the free end of arms 24, 26 passes through an opening 40 in the part 16, and the length of the arms supports each part by engaging a surface 42 on the part. As arms 24 are raised, the parts 16 are lifted from the load bed 12, allowing the cart 10 to be removed from the transfer device 20, loaded with a new batch of parts 16 and returned to the device 20. The transfer device 20 remains in the position shown in FIG. 2 until the production operator is ready for a more parts to process.

When the production operator has removed each part 16 from the arms 26 that are located at the workstation 30, the stand 22 is rotated about axis 28, thereby moving arms 26 from the workstation to the diametrically opposite location, where they await being used to unload a batch of parts 16 from cart 10. This rotation moves the arms 24 on which the parts 16 are carried to workstation 30 from the diametrically opposite location, where the batch of parts 16 were unloaded from a cart 10. Then the production operator removes parts 16 from arms 24 until those arms are empty, whereupon the stand rotates another batch of parts on arms 26 to workstation 30.

In accordance with the provisions of the patent statutes, the preferred embodiment has been described. However, it should be noted that the alternate embodiments can be practiced otherwise than as specifically illustrated and described.

1. (canceled)

2. (canceled)

3. (canceled)

4. (canceled)

5. (canceled)

6. (canceled)

7. (canceled)

8. A system for receiving and presenting parts, comprising:
a rotatable stand including first and second pairs of spaced arms, the stand able to rotate about an axis to between first and second locations;
actuators for raising and lowering each of the pairs of arms to an elevation different from an elevation of the other pair of arms; and
a cart including a load bed on which a batch of parts is supported while the batch is transport on the cart to the first location, a vertical position of the load bed being fixed, immoveable, and located such that one of the first and the second pairs of arms engages the parts at a vertical position above the load bed while the batch is located on the load bed and before said pair of arms lifts the batch from the load bed.

9. A system of claim 8 wherein the cart provides access to the batch of parts such that said one of the first and the second pairs of arms passes through the batch and engages a surface on each part of the batch.

10. The system of claim 8 further comprising:
first and second tracks supported on and directed along a length of the stand;
a first trolley guided for movement in the first track and secured to a first of the actuators;
a first assembly secured to the first trolley and including the first pair of arms;
a second trolley guided for movement in a second track and secured to a second of the actuators; and
a second assembly secured to the second trolley and including the second pair of arms.

11. The system of claim 8 further comprising a bearing supporting the stand for rotation about the axis.

12. The system of claim 8 wherein each pair of arms includes a first end secured to the stand and a second end that extends outward from the stand and into the parts of the batch.

13. The system of claim 8 wherein each arm of the first pair of arms is mutually parallel and extends outward from the stand, and each arm of the second pair of arms is mutually parallel and extends outward from the stand from an opposite side of the axis from the first arms.

14. The system of claim 8 further comprising a third actuator for rotating the stand about the axis.

15. A method for operating a transfer device, comprising the steps of:
(a) providing a rotatable stand including first and second angularly spaced arms able to rotate about an axis between first and second locations;
(b) moving a cart supporting a batch of parts on a fixed, immoveable load bed to the first location;
(c) using the first arms to engage the batch of parts at a vertical position above the load bed while the batch is located on the load bed and before the first arms lift the batch from the load bed;
(d) raising the first arms and the batch of parts from the cart to an elevation different from that of the second arms; and
(e) rotating the batch of parts to the second location.

16. The method of claim 15 wherein step (e) further includes rotating the second arms to the first location.

17. The method of claim 15 further comprising:
removing the cart from the first location;
loading the cart with a second batch of parts; and
returning the reloaded cart to the first location.

18. The method of claim 15 further comprising:
removing the cart from the first location;
loading a second cart with a second batch of parts; and
moving the second cart to the first location.

19. The system of claim 8, wherein the load bed is supported on front wheels and rear wheels such that the batch of parts while on the load bed is located between the front wheels and rear wheels and without overhanging the wheels.

20. The system of claim 8, wherein the stand rotates about the axis to between first and second locations without translation.
